(19) United States
(12) Patent Application Publication
(10) Pub. No.: US 2026/0255267 A1
(43) Pub. Date: Aug. 27, 2026

(54) COMMUNICATION SYSTEM, MANAGEMENT DEVICE, COMMUNICATION METHOD, AND STORAGE MEDIUM STORING PROGRAM

(71) Applicant: DENSO CORPORATION, Kariya-shi (JP)

(72) Inventors: Yukihiro YAMAKAWA, Kariya-shi (JP); Tomoya TOKUNAGA, Kariya-shi (JP); Mana TANAKA, Kariya-shi (JP); Yoji HOMMA, Kariya-shi (JP)

(21) Appl. No.: 19/541,471

(22) Filed: Feb. 17, 2026

(30) Foreign Application Priority Data
Feb. 26, 2025 (JP) 2025-029022

(51) Int. Cl. H04W 52/02; H04B 1/40

(52) U.S. Cl. CPC H04W 52/0229; H04B 1/40

(57) ABSTRACT

A communication system mounted on a vehicle includes a management device, and an electronic control unit configured to communicate with the management device. The electronic control unit is started by power supply from an external source via a semiconductor switch, and is stopped by power disconnection from the external source via the semiconductor switch. While in a powered state, the electronic control unit is configured to switch to perform startup by switching to a wake-up state and to stop by switching to a sleep state, based on a communication frame received from an external source. Upon determination to stop the electronic control unit, the management device transmits, as a first transmission after the determination, a stop request to the electronic control unit multiple times in succession.

### CROSS REFERENCE TO RELATED APPLICATION

This application is based on Japanese Patent Application No. 2025-29022 filed on February 26, 2025, the disclosure of which is incorporated herein by reference.

### TECHNICAL FIELD

The present disclosure relates to a management device, and a communication system including the management device and an electronic control unit (ECU) disposed so as to be capable of communicating with the management device, the communication system being mounted on a vehicle. The present disclosure further relates to the management device, a communication method, and a computer program.

### BACKGROUND

With respect to safety requirements for vehicles, criteria such as risk ranks are established according to the degree of impact of system abnormalities. For system abnormalities with a high risk rank, that is, those with a significant impact, it may be necessary to ensure safety by implementing measures such as redundant design. On the other hand, for system abnormalities with limited impact, it may be often difficult to adopt a redundant configuration from a cost perspective, and therefore a non-redundant configuration is frequently employed.

In vehicles, techniques are known for reducing the overall power consumption of the system by transitioning unnecessary ECUs from a wake-up state to a sleep state. As a means for starting and stopping ECUs, for example, a related art discloses a configuration in which mechanical relay control is performed for each system.

### SUMMARY

According to an aspect of the present disclosure, a communication system mounted on a vehicle includes a management device, and an electronic control unit configured to communicate with the management device. The electronic control unit may be started by power supply from an external source via a semiconductor switch, and be stopped by power disconnection from the external source via the semiconductor switch. While in a powered state, the electronic control unit may be configured to switch to perform startup by switching to a wake-up state and to stop by switching to a sleep state, based on a communication frame received from an external source. Upon determination to stop the electronic control unit, the management device may transmit, as a first transmission after the determination, a stop request to the electronic control unit multiple times in succession.

### BRIEF DESCRIPTION OF DRAWINGS

Objects, features and advantages of the present disclosure will become more apparent from the following detailed description made with reference to the accompanying drawings. In the drawings:

FIG. 1 is a functional block diagram showing the overall configuration in the first embodiment;

FIG. 2 is a functional block diagram of the mobility computer;

FIG. 3 is a functional block diagram of the power distribution management ECU;

FIG. 4 is a functional block diagram of the zone ECU;

FIG. 5 is a functional block diagram of the first end ECU;

FIG. 6 is a flowchart illustrating the processing content of the mobility computer;

FIG. 7 is a flowchart illustrating the processing content of the ECU that has received the first message;

FIG. 8 is a sequence diagram for transmitting the IPD OFF signal;

FIG. 9 is a sequence diagram for transmitting the IPD ON signal;

FIG. 10 is a flowchart illustrating the process of transitioning to the sleep state when a certain period has elapsed without receiving a communication frame for a wake-up request;

FIG. 11 is a diagram showing the data format of the third message in the second embodiment; and

FIG. 12 is a diagram showing the transmission format of the third message.

### DETAILED DESCRIPTION

In a related art, it is envisioned that the mechanical relay may be replaced, for example, with a semiconductor switch, and that a device sends a message to the ECU to turn the semiconductor switch on or off, thereby switching between the wake-up state and the sleep state. In the aforementioned non-redundant configuration, if power control is performed via message communication, communication abnormalities such as message corruption or timeout of transmission may occur. In such cases, the stop request may not be transmitted, resulting in the power remaining in the ON state and potentially causing depletion of the battery power.

The present disclosure provides a communication system, management device, communication method, and computer program capable of more reliably performing power control of electronic control units (ECUs) via message communication.

According to one aspect of the present disclosure, a communication system mounted on a vehicle includes a management device, and an electronic control unit configured to communicate with the management device. The electronic control unit is started by power supply from an external source via a semiconductor switch, and is stopped by power disconnection from the external source via the semiconductor switch. While in a powered state, the electronic control unit is configured to switch to perform startup by switching to a wake-up state and to stop by switching to a sleep state, based on a communication frame received from an external source. Upon determination to stop the electronic control unit, the management device transmits, as a first transmission after the determination, a stop request to the electronic control unit multiple times in succession.

Preferably, when the management device determines to activate the electronic control unit, it may also transmit the startup request to the electronic control unit multiple times consecutively. Thus, activation of the electronic control unit can be performed more reliably, similarly to the case of stop.

An embodiment will be described with reference to the drawings. The communication system 1 is based on a zone architecture and is configured to include a plurality of ECUs arranged according to zones, which indicate installation locations such as the front, rear, left, and right of the vehicle body.

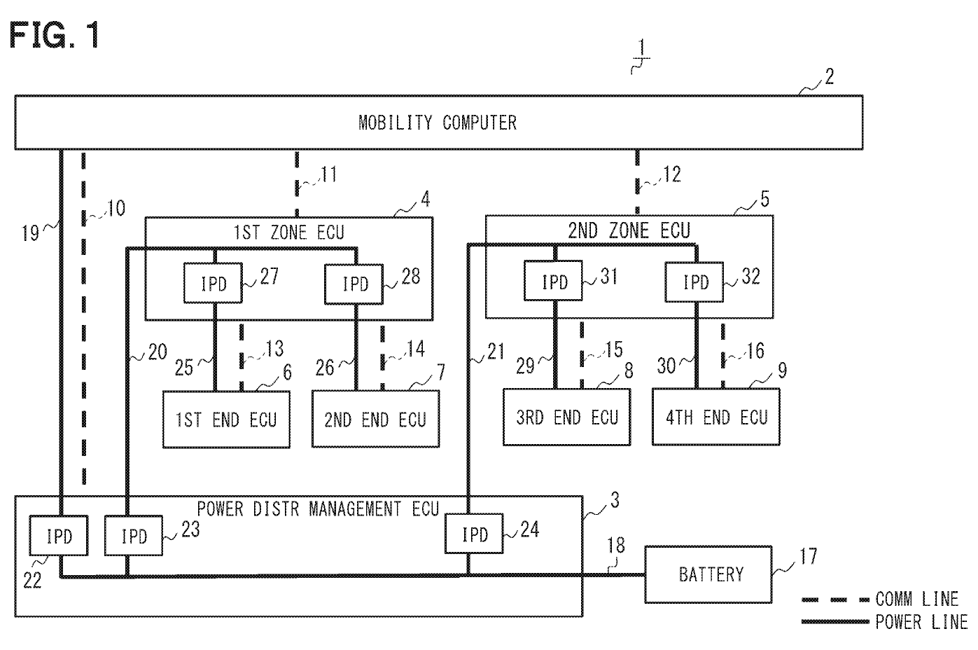

As shown in FIG. 1, the communication system 1 mounted on a vehicle comprises a mobility computer (also may be referred to as "mobicon") 2, which corresponds to the management device; a power distribution management ECU 3, which corresponds to the power distribution management device and is communicably connected to the mobility computer 2; a first zone ECU 4 and a second zone ECU 5, which correspond to first electronic control units; a first end ECU 6 and a second end ECU 7, which correspond to second electronic control units and are communicably connected to the first zone ECU 4; and a third end ECU 8 and a fourth end ECU 9, which correspond to second electronic control units and are communicably connected to the second zone ECU 5.

In FIG. 1, two zone ECUs 4 and 5 communicably connected to the mobility computer 2 are illustrated as examples; however, the number of zone ECUs communicably connected to the mobility computer 2 may be one or three or more. Similarly, two end ECUs 6 and 7 communicably connected to the first zone ECU 4 are illustrated as examples; however, the number of end ECUs communicably connected to the first zone ECU 4 may be one or three or more. Likewise, two end ECUs 8 and 9 communicably connected to the second zone ECU 5 are illustrated as examples; however, the number of end ECUs communicably connected to the second zone ECU 5 may be one, or three or more.

The mobility computer 2 is a control device capable of controlling the operations of the power distribution management ECU 3, zone ECUs 4 and 5, and end ECUs 6 to 9. The mobility computer 2 and the power distribution management ECU 3 are communicably connected via a communication line 10. The mobility computer 2 and the first zone ECU 4 are communicably connected via a communication line 11. The mobility computer 2 and the second zone ECU 5 are communicably connected via a communication line 12.

The first zone ECU 4 and the first end ECU 6 are communicably connected via a communication line 13. The first zone ECU 4 and the second end ECU 7 are communicably connected via a communication line 14. The second zone ECU 5 and the third end ECU 8 are communicably connected via a communication line 15. The second zone ECU 5 and the fourth end ECU 9 are communicably connected via a communication line 16. Each of the communication lines 10 to 16 is, for example, a communication line capable of communication based on a communication frame conforming to communication protocols such as CAN (Controller Area Network, registered trademark) or CAN FD (CAN With Flexible Data Rate, registered trademark).

The power distribution management ECU 3 is supplied with power from the battery 17 via the power line 18, distributes the power supplied from the battery 17 to the mobility computer 2 and the zone ECUs 4 and 5, distributes power to the end ECUs 6 and 7 via the first zone ECU 4, and distributes power to the end ECUs 8 and 9 via the second zone ECU 5.

The power distribution management ECU 3 and the mobility computer 2 are connected so as to allow power distribution via the power line 19. The power distribution management ECU 3 is provided with an IPD (Intelligent Power Device) 22, which is a high-performance semiconductor power switch interposed between the power line 18 and the power line 19. The IPD is a high-performance semiconductor power switch equipped with a protection circuit and capable of absorbing energy from inductive loads and the like. The IPD may also be referred to as a semiconductor fuse, IPS (Intelligent Power Switch), smart switch, or high-side/low-side switch. Compared to a mechanical relay having mechanical contacts, the IPD does not have mechanical contacts, and therefore offers advantages such as superior mechanical durability, quiet operation, and a more compact size. Furthermore, since it is equipped with protection functions not present in mechanical relays, high reliability can also be achieved.

The IPD 22 is basically always ON, and power from the battery 17 is constantly supplied to the mobility computer 2. In the present embodiment, the IPD 22 is basically always ON, but a configuration in which the IPD 22 can be turned OFF is also possible. For example, in cases where the system is not used for an extended period, such as during transportation by ship or other situations, the IPD 22 can be temporarily turned OFF to suppress the quiescent current flowing to the mobility computer 2, thereby reducing power consumption of the battery 17.

When the IPD 22 is temporarily turned OFF, power supply from the battery 17 to the mobility computer 2 is interrupted. However, it is also possible to configure the system such that the mobility computer 2 operates in a low-power consumption state, for example, powered by a battery during the period when power supply is stopped, thereby enabling switching of the IPD 22 from OFF to ON. Alternatively, the mobility computer 2 and the battery 17 may be directly connected so that power from the battery 17 is constantly supplied to the mobility computer 2. In such a case, the power line 19 and the IPD 22 may be omitted.

The power distribution management ECU 3 and the first zone ECU 4 are connected so as to allow power distribution via the power line 20. The power distribution management ECU 3 and the second zone ECU 5 are connected so as to allow power distribution via the power line 21. The power distribution management ECU 3 is provided with an IPD 23 interposed between the power line 18 and the power line 20, and an IPD 24 interposed between the power line 18 and the power line 21.

The power distribution management ECU 3 turns the IPD 23 ON or OFF based on ON/OFF instructions for the IPD 23 from the mobility computer 2, thereby switching between the power supply state and the power disconnected state for the first zone ECU 4. That is, when the IPD 23 is ON, power supply from the power distribution management ECU 3 to the first zone ECU 4 is started, and when the IPD 23 is OFF, power supply from the power distribution management ECU 3 to the first zone ECU 4 is terminated. The power distribution management ECU 3 turns the IPD 24 ON or OFF based on ON/OFF instructions for the IPD 24 from the mobility computer 2, thereby switching between the power supply state and the power disconnected state for the second zone ECU 5. That is, when the IPD 24 is ON, power supply from the power distribution management ECU 3 to the second zone ECU 5 is started, and when the IPD 24 is OFF, power supply from the power distribution management ECU 3 to the second zone ECU 5 is terminated.

The first zone ECU 4 and the first end ECU 6 are connected so as to allow power distribution via the power line 25. The first zone ECU 4 and the second end ECU 7 are connected so as to allow power distribution via the power line 26. The first zone ECU 4 is provided with an IPD 27 interposed between the power line 20 and the power line 25, and an IPD 28 interposed between the power line 20 and the power line 26.

The first zone ECU 4 turns the IPD 27 ON or OFF based on ON/OFF instructions for the IPD 27 from the mobility computer 2, thereby switching between the power supply state and the power disconnected state for the first end ECU 6. That is, when the IPD 27 is ON, power supply from the first zone ECU 4 to the first end ECU 6 is started, and when the IPD 27 is OFF, power supply from the first zone ECU 4 to the first end ECU 6 is terminated. The first zone ECU 4 turns the IPD 28 ON or OFF based on ON/OFF instructions for the IPD 28 from the mobility computer 2, thereby switching between the power supply state and the power disconnected state for the second end ECU 7. That is, when the IPD 28 is ON, power supply from the first zone ECU 4 to the second end ECU 7 is started, and when the IPD 28 is OFF, power supply from the first zone ECU 4 to the second end ECU 7 is terminated.

The second zone ECU 5 and the third end ECU 8 are connected so as to allow power distribution via the power line 29, and the second zone ECU 5 and the fourth end ECU 9 are connected so as to allow power distribution via the power line 30. The second zone ECU 5 is provided with an IPD 31 interposed between the power line 21 and the power line 29, and an IPD 32 interposed between the power line 21 and the power line 30.

The second zone ECU 5 turns the IPD 31 ON or OFF based on ON/OFF instructions for the IPD 31 from the mobility computer 2, thereby switching between the power supply state and the power disconnected state for the third end ECU 8. That is, when the IPD 31 is ON, power supply from the second zone ECU 5 to the third end ECU 8 is started, and when the IPD 31 is OFF, power supply from the second zone ECU 5 to the third end ECU 8 is terminated. The second zone ECU 5 turns the IPD 32 ON or OFF based on ON/OFF instructions for the IPD 32 from the mobility computer 2, thereby switching between the power supply state and the power disconnected state for the fourth end ECU 9. That is, when the IPD 32 is ON, power supply from the second zone ECU 5 to the fourth end ECU 9 is started, and when the IPD 32 is OFF, power supply from the second zone ECU 5 to the fourth end ECU 9 is terminated.

In the above configuration, it is also possible for a part of the zone ECUs 4, 5 and end ECUs 6 to 9 to be directly connected to the battery 17, so that power from the battery 17 is constantly supplied.

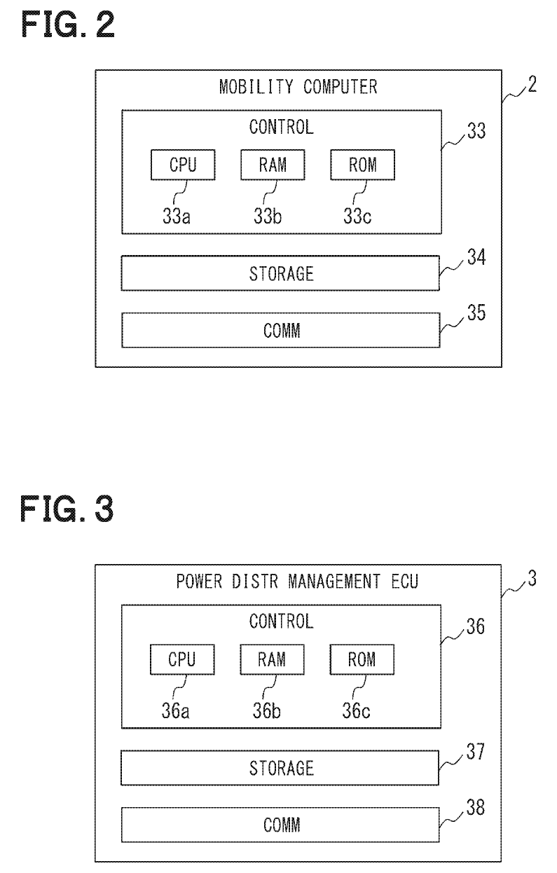

As shown in FIG. 2, the mobility computer 2 comprises a mobility computer control unit 33 (corresponding to the control unit), a mobility computer storage unit 34, and a mobility computer communication unit 35. The mobility computer control unit 33 is a device that performs various arithmetic processes related to the operation of the mobility computer 2, and is mainly constituted by a microcomputer (hereinafter referred to as "microcontroller") having, for example, a CPU 33a, RAM 33b, ROM 33c, and the like. The various functions of the mobility computer control unit 33 are realized by the CPU 33a executing a program stored in a non-transitory tangible recording medium. The non-transitory tangible recording medium is, for example, the ROM 33c. When the program is executed by the CPU 33a, the method corresponding to the program is executed.

In the present embodiment, when the startup/shutdown control program for the electronic control unit is executed by the CPU 33a, the startup/shutdown control method corresponding to the startup/shutdown control program for the electronic control unit is executed. The startup/shutdown control may also be referred to as a startup/stop control. The number of microcontrollers constituting the mobility computer control unit 33 may be one or more. Further, the means for realizing the various functions of the mobility computer control unit 33 is not limited to software, and some or all elements may be realized using one or more hardware components. For example, when the above-described functions are realized by electronic circuits as hardware, such electronic circuits may be digital circuits including a large number of logic circuits, analog circuits, or a combination thereof.

The mobility computer storage unit 34 is, for example, a non-volatile memory, such as a rewritable flash memory or EEPROM. The mobility computer storage unit 34 stores, for example, the vehicle power supply state, which will be described later. The mobility computer communication unit 35 controls data communication with the power distribution management ECU 3 via the communication line 10, data communication with the first zone ECU 4 via the communication line 11, and data communication with the second zone ECU 5 via the communication line 12.

As shown in FIG. 3, the power distribution management ECU 3 comprises a power distribution management control unit 36, a power distribution management storage unit 37, and a power distribution management communication unit 38. The power distribution management control unit 36 is a device that performs various arithmetic processes related to the operation of the power distribution management ECU 3, and is mainly constituted by a microcontroller having, for example, a CPU 36a, RAM 36b, ROM 36c, and the like. The various functions of the power distribution management control unit 36 are realized by the CPU 36a executing a program stored in a non-transitory tangible recording medium. The non-transitory tangible recording medium is, for example, the ROM 36c. When the program is executed by the CPU 36a, the method corresponding to the program is executed.

In the present embodiment, when the vehicle power supply state management program is executed by the CPU 36a, the management method corresponding to the vehicle power supply state management program is executed. The number of microcontrollers constituting the power distribution management control unit 36 may be one or more. Further, the means for realizing the various functions of the power distribution management control unit 36 is not limited to software, and some or all elements may be realized using one or more hardware components. For example, when the above-described functions are realized by electronic circuits as hardware, such electronic circuits may be digital circuits including a large number of logic circuits, analog circuits, or a combination thereof.

The power distribution management storage unit 37 is, for example, a non-volatile memory, such as a rewritable flash memory or EEPROM. The vehicle power supply state is stored in the power distribution management storage unit 37. In addition, a volatile memory may be provided separately from the power distribution management storage unit 37, and the vehicle power supply state may be stored in the volatile memory. The power distribution management communication unit 38 controls data communication with the mobility computer 2 via the communication line 10.

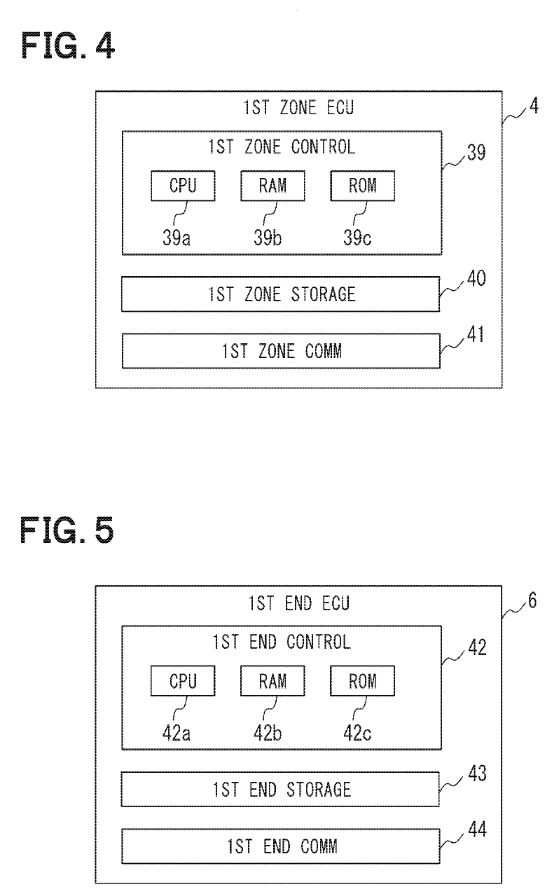

As shown in FIG. 4, the first zone ECU 4 comprises a first zone control unit 39, a first zone storage unit 40, and a first zone communication unit 41. The second zone ECU 5 has the same configuration as the first zone ECU 4. The first zone control unit 39 is a device that performs various arithmetic processes related to the operation of the first zone ECU 4, and is mainly constituted by a microcontroller having, for example, a CPU 39a, RAM 39b, ROM 39c, and the like. The various functions of the first zone control unit 39 are realized by the CPU 39a executing a program stored in a non-transitory tangible recording medium. The non-transitory tangible recording medium is, for example, the ROM 39c. When the program is executed by the CPU 39a, the method corresponding to the program is executed.

In the present embodiment, when the vehicle power supply state management program is executed by the CPU 39a, the management method corresponding to the vehicle power supply state management program is executed. The number of microcontrollers constituting the first zone control unit 39 may be one or more. Further, the means for realizing the various functions of the first zone control unit 39 is not limited to software, and some or all elements may be realized using one or more hardware components. For example, when the above-described functions are realized by electronic circuits as hardware, such electronic circuits may be digital circuits including a large number of logic circuits, analog circuits, or a combination thereof.

The first zone storage unit 40 is, for example, a non-volatile memory, such as a rewritable flash memory or EEPROM. The vehicle power supply state is stored in the first zone storage unit 40. In addition, a volatile memory may be provided separately from the first zone storage unit 40, and the vehicle power supply state may be stored in the volatile memory. The first zone communication unit 41 controls data communication with the mobility computer 2 via the communication line 11, data communication with the first end ECU 6 via the communication line 13, and data communication with the second end ECU 7 via the communication line 14.

As shown in FIG. 5, the first end ECU 6 comprises a first end control unit 42, a first end storage unit 43, and a first end communication unit 44. The second end ECU 7, third end ECU 8, and fourth end ECU 9 have the same configuration as the first end ECU 6. The first end control unit 42 is a device that performs various arithmetic processes related to the operation of the first end ECU 6, and is mainly constituted by a microcontroller having, for example, a CPU 42a, RAM 42b, ROM 42c, and the like. The various functions of the first end control unit 42 are realized by the CPU 42a executing a program stored in a non-transitory tangible recording medium. The non-transitory tangible recording medium is, for example, the ROM 42c. When the program is executed by the CPU 42a, the method corresponding to the program is executed.

In the present embodiment, when the vehicle power supply state management program is executed by the CPU 42a, the management method corresponding to the vehicle power supply state management program is executed. The number of microcontrollers constituting the first end control unit 42 may be one or more. Further, the means for realizing the various functions of the first end control unit 42 is not limited to software, and some or all elements may be realized using one or more hardware components. For example, when the above-described functions are realized by electronic circuits as hardware, such electronic circuits may be digital circuits including a large number of logic circuits, analog circuits, or a combination thereof.

The first end storage unit 43 is, for example, a non-volatile memory, such as a rewritable flash memory or EEPROM. The vehicle power supply state is stored in the first end storage unit 43. In addition, a volatile memory may be provided separately from the first end storage unit 43, and the vehicle power supply state may be stored in the volatile memory. The first end communication unit 44 controls data communication with the first zone ECU 4 via the communication line 13.

In the communication system 1, startup/shutdown control corresponding to the first startup/shutdown control is performed by relay-based startup/shutdown control based on ON/OFF of the IPD, and startup/shutdown control corresponding to the second startup/shutdown control is performed by switching to the wake-up state or sleep state based on a communication frame (also referred to as an NM (Network Management) frame or NM message). The latter may be referred to as startup/shutdown control based on a communication frame.

The startup/shutdown control via relay includes startup control via relay based on turning the IPD ON, and stop control via relay based on turning the IPD OFF. The startup/shutdown control based on a communication frame includes startup control by switching from the sleep state to the wake-up state based on a communication frame for a wake-up request, and stop control by switching from the wake-up state to the sleep state based on a communication frame for a sleep request.

The startup/shutdown control via relay uses the IPD ON signal for instructing the IPD to turn ON, and the IPD OFF signal for instructing the IPD to turn OFF. That is, the ECU that receives the IPD ON signal from the mobility computer 2 turns ON the IPD specified by the received IPD ON signal, and starts supplying power to the ECUs under the power supply of the turned-on IPD. The ECU that receives the IPD OFF signal from the mobility computer 2 turns OFF the IPD specified by the received IPD OFF signal, and terminates power supply to the ECUs under the power supply of the turned-off IPD. The IPD ON signal and IPD OFF signal correspond to the first message.

The startup/shutdown control based on a communication frame uses the value of a predetermined bit in the data field of the communication frame. For example, a communication frame in which "1" is stored in a predetermined bit of the data field is used as a communication frame for a wake-up request, and a communication frame in which "0" is stored in a predetermined bit of the data field is used as a communication frame for a sleep request. That is, the ECU that receives a communication frame from the mobility computer 2 determines the value stored in the predetermined bit of the received communication frame; if it is "1", the ECU transitions from the sleep state to the wake-up state or continues the wake-up state; if it is "0", the ECU transitions from the wake-up state to the sleep state or continues the sleep state. The communication frame for performing startup/shutdown control corresponds to the second message.

In addition, in the ECU, the wake-up state may be continued during the period in which communication frames for wake-up requests are periodically received from the mobility computer 2 at a predetermined cycle, and when a certain period has elapsed without receiving the communication frame for a wake-up request, the ECU may transition from the wake-up state to the sleep state. The wake-up state is a normal operating state in which the functions assigned to the ECU are available without restriction. The sleep state is a low-power operating state in which the available functions are restricted. Here, the communication frame may be transmitted not only from the mobility computer 2 but also from other ECUs.

The mobility computer 2, as startup/shutdown control via relay, transmits an IPD ON signal to the ECU positioned at a higher level than the ECU to be controlled, and turns ON the corresponding IPD to perform startup control for the target ECU. It transmits an IPD OFF signal and turns OFF the corresponding IPD to perform stop control for the target ECU. That is, for example, when the ECU to be controlled is the first zone ECU 4, the mobility computer 2 transmits an IPD ON signal to the power distribution management ECU 3, which is positioned at a higher level than the first zone ECU 4, and turns ON the IPD 23 to activate the first zone ECU 4. It transmits an IPD OFF signal and turns OFF the IPD 23 to stop the first zone ECU 4. Further, for example, when the ECU to be controlled is the first end ECU 6, the mobility computer 2 transmits an IPD ON signal to the first zone ECU 4, which is positioned at a higher level than the first end ECU 6, and turns ON the IPD 27 to activate the first end ECU 6. It transmits an IPD OFF signal and turns OFF the IPD 27 to stop the first end ECU 6.

The mobility computer 2, as startup/shutdown control based on a communication frame, transitions the target ECU to the wake-up state by transmitting a communication frame for a wake-up request addressed to the target ECU, and transitions the target ECU to the sleep state by transmitting a communication frame for a sleep request. That is, for example, when the ECU to be controlled is the first zone ECU 4, the mobility computer 2 transmits a communication frame for a wake-up request addressed to the first zone ECU 4 to transition the first zone ECU 4 to the wake-up state, and transmits a communication frame for a sleep request to transition it to the sleep state.

Further, for example, when the ECU to be controlled is the first end ECU 6, the mobility computer 2 transmits a communication frame for a wake-up request addressed to the first end ECU 6 to transition the first end ECU 6 to the wake-up state, and transmits a communication frame for a sleep request to transition it to the sleep state. Note that an ECU to which power supply is started by the IPD ON at a higher level naturally enters the wake-up state, and therefore, transmission of a communication frame for a wake-up request from the mobility computer 2 to such an ECU for which power supply has started is unnecessary.

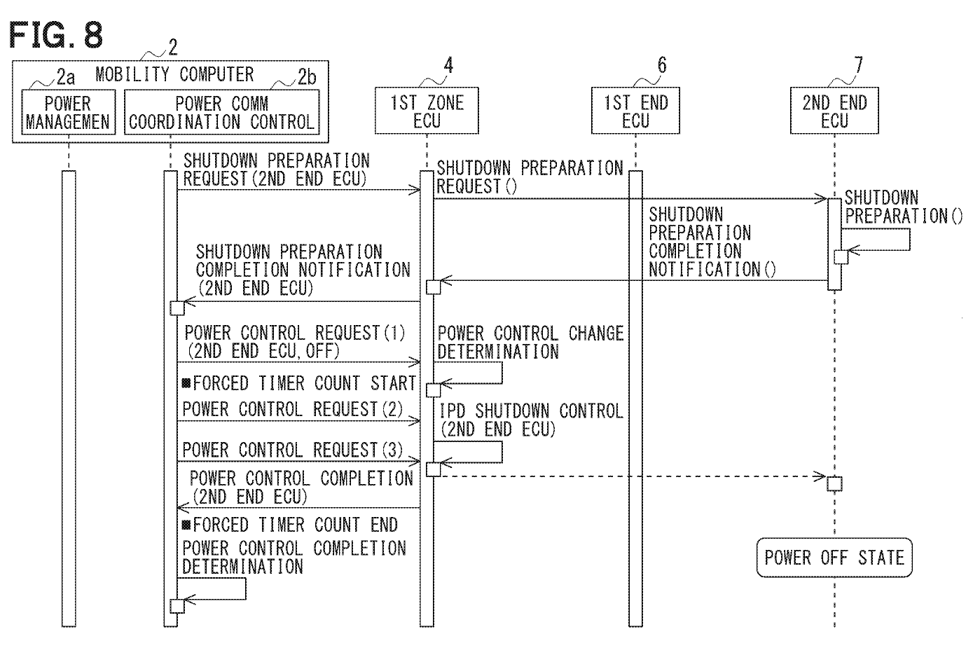

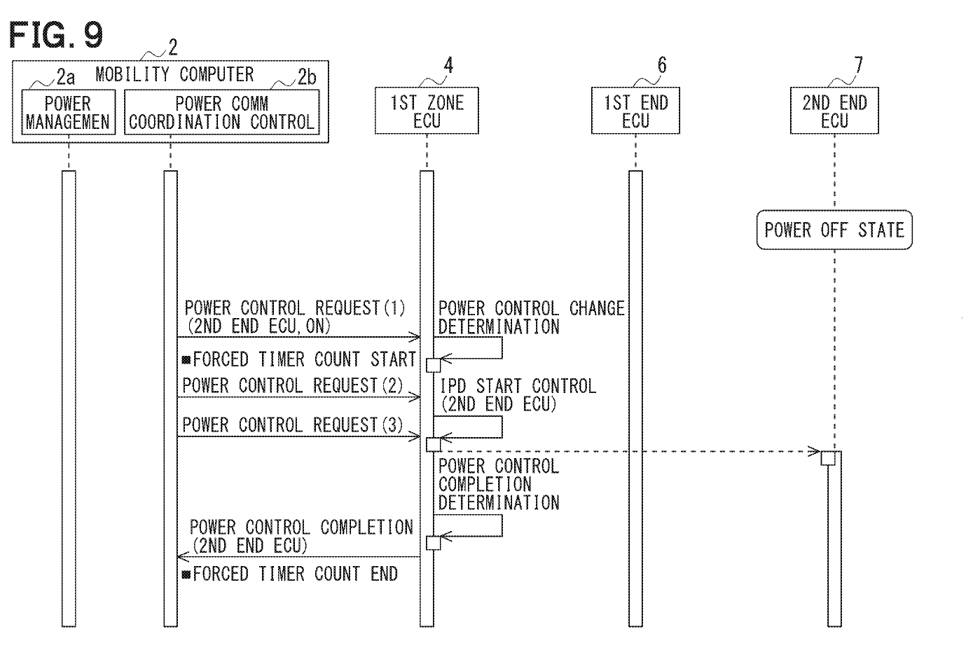

Next, the operation of the present embodiment will be described. In the following, the first zone ECU 4 and the second end ECU 7 connected downstream thereof are taken as the control targets. In FIG. 8 and FIG. 9, the power management unit 2a and the power communication coordination control unit 2b are shown as functional blocks within the mobility computer 2. These are functions realized by the mobility computer control unit 33 through execution of software. The power management unit 2a manages the power supply state from the battery 17 supplied via +B, accessory switch, ignition switch, and the like. The operation described below is executed exclusively by the power communication coordination control unit 2b.

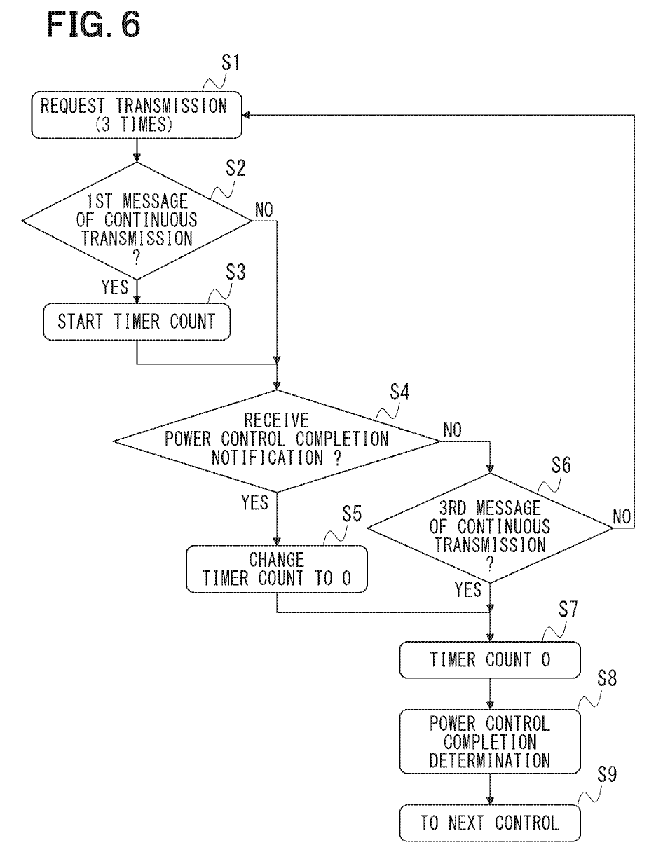

As shown in FIG. 6, and in FIG. 8 and FIG. 9, in the present embodiment, the power communication coordination control unit 2b of the mobility computer 2 transmits the power control request, which is startup/shutdown control via relay, to the first zone ECU 4 consecutively, for example, three times. FIG. 8 illustrates the case where the IPD OFF signal is transmitted. The mobility computer 2 first transmits a stop preparation request to the first zone ECU 4 for the second end ECU 7. The first zone ECU 4 forwards the received stop preparation request to the second end ECU 7.

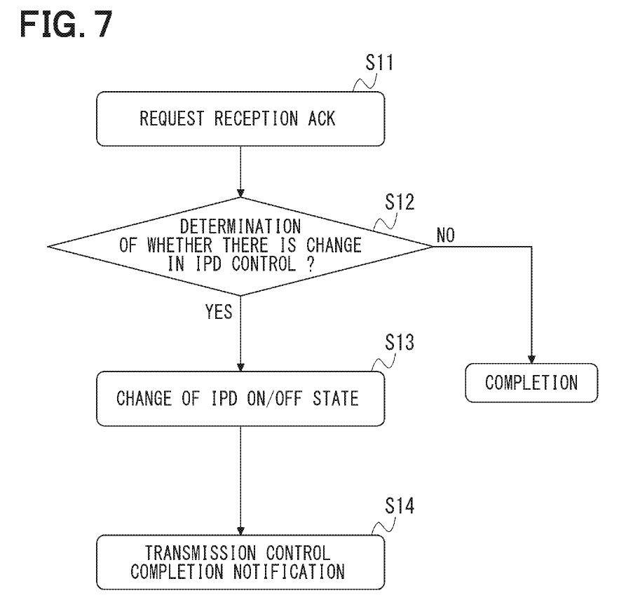

When the second end ECU 7 receives the stop preparation request, it executes stop preparation processing, such as storing data currently held at that time in the first end storage unit 43, in preparation for power disconnection. Upon completion of the stop preparation processing, a stop preparation completion notification is transmitted to the first zone ECU 4. The first zone ECU 4 forwards the received stop preparation completion notification to the mobility computer 2. FIG. 6 and FIG. 7 correspond to the processing after this point. Here, “stop preparation” is also referred to as “shutdown preparation”.

When the mobility computer 2 transmits the first power control request (1) (Yes at S1), it starts the forced timer count (S2). In step S3, it is determined whether a power control completion notification has been received; if not (NO), it is determined in step S6 whether the power control request (3) has been transmitted. If the power control request (3) has not yet been transmitted (NO), the process returns to step S1.

As shown in FIG. 7, when the first zone ECU 4 receives a power control request (S11), it determines whether there is a change in the ON/OFF state of IPD 28 (S12). In FIG. 8, at the time the power control request (1) is received, IPD 28 is in the ON state, and since it is to be changed to the OFF state, the determination is "YES." Then, IPD 28 is turned OFF (S13). As a result, power supply to the second end ECU 7 is disconnected, and the second end ECU 7 is stopped.

The mobility computer 2 transmits power control requests (2) and (3) following the transmission of power control request (1). If the first zone ECU 4 receives power control requests (2) or (3) while IPD 28 is already OFF, there is no change in the control state, so the determination in step S12 is "NO." After executing step S13, the first zone ECU 4 transmits a power control completion notification for the second end ECU 7 to the mobility computer 2 (S14).

When the mobility computer 2 receives the power control completion notification (Yes at S4), it clears the forced timer count to zero (S5, S7) and performs the power control completion determination (S8). Thereafter, it transitions to the next control. If the power control request (3) is transmitted before receiving the power control completion notification (No at S4), and if step S6 is Yes, the process proceeds to step S7. The duration for the forced timer count is set longer than the time required to transmit power control requests (1) to (3).

FIG. 9 illustrates the case where the IPD ON signal is transmitted to change IPD 28 from OFF to ON. Basically, this is similar to the case described above where IPD 28 is changed from ON to OFF. However, the difference is that the power control completion determination is performed by the first zone ECU 4 rather than the mobility computer 2. This represents a variation in the control mode, and the power control completion determination may be performed by the mobility computer 2, as in the case shown in FIG. 8.

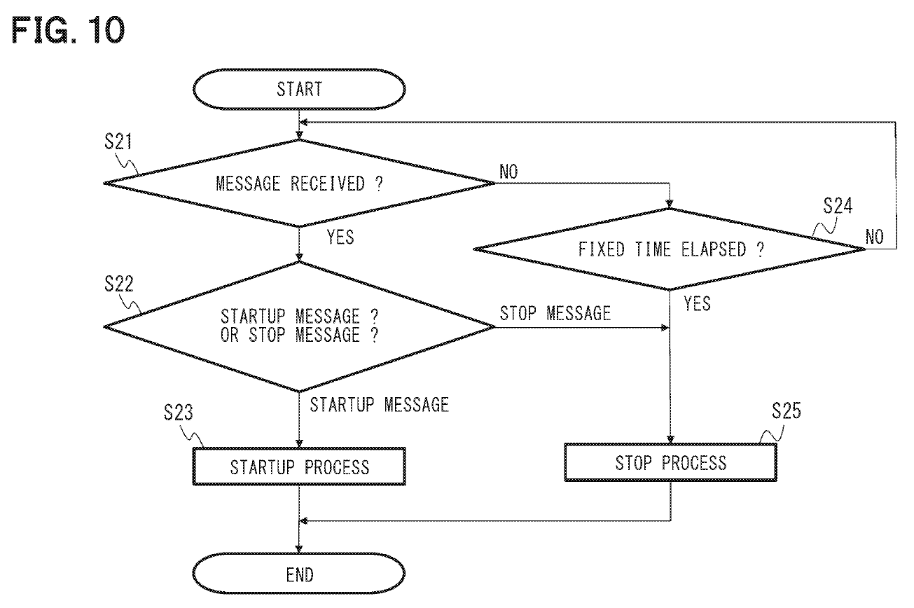

FIG. 10 is a flowchart illustrating the process in which, as previously described, when a certain period has elapsed without receiving a communication frame for a wake-up request, the system transitions from the wake-up state to the sleep state. For example, the first zone ECU 4 determines whether a message has been received from the mobility computer 2 until a certain period has elapsed (No at S24) (S21). If a message is received (Yes), it is determined whether the message is a startup message or a stop message (S22). For example, if it is a startup message targeting the first end ECU 6, startup processing is performed (S23), and the first end ECU 6 transitions to the wake-up state.

On the other hand, if the received message is a stop message, stop processing is performed (S25), and the first end ECU 6 transitions to the sleep state. In addition, if a certain period has elapsed in step S24 (Yes), the process also proceeds to step S25. If, at the time the message is received, the first end ECU is already in the wake-up state, step S23 is skipped. Similarly, if the first end ECU is in the sleep state, step S25 is skipped.

As described above, according to the present embodiment, the communication system 1 mounted on a vehicle includes the mobility computer 2 and ECUs 4 to 9 arranged to be capable of communicating with the mobility computer 2. The ECUs 4 to 9 are activated by power supply from the battery 17 via IPDs 23, 24, 27, 28, 31, and 32, and are stopped by power disconnection from the battery 17 via IPDs 23, 24, 27, 28, 31, and 32. Further, the ECUs 4 to 9, while in a powered state, perform startup by switching to the wake-up state and stop by switching to the sleep state based on communication frames received from the mobility computer 2. When the mobility computer 2 determines to stop ECUs 4 to 9, it transmits the stop request to ECUs 4 to 9 consecutively multiple times.

With this configuration, even if some of the stop requests are not properly transmitted to ECUs 4 to 9 due to message corruption or the like, the stop of ECUs 4 to 9 can be performed more reliably. In addition, when the mobility computer 2 determines to start up ECUs 4 to 9, it also transmits the startup request to ECUs 4 to 9 consecutively multiple times. Thus, startup of ECUs 4 to 9 can also be performed more reliably, in the same manner as stop.

### Second Embodiment

The same reference numerals are used for parts identical to those in the first embodiment, and explanations thereof are omitted; only the differing parts will be described. In the second embodiment, for example, in order to switch IPDs 27 and 28 to the ON or OFF state, or to switch the first end ECU 6 and the second end ECU 7 to the wake-up state or sleep state, an NM frame, which is a CAN frame containing the first message and the second message, is used. In the following, the first message may be referred to as switching information, and the second message may be referred to as startup information.

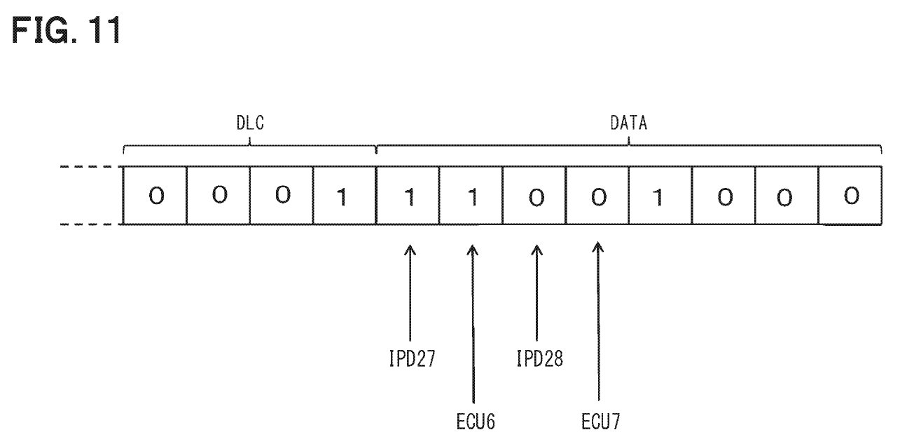

The first message is information indicating whether to turn IPDs 27 and 28 ON. The second message is information indicating whether to transition the first end ECU 6 and the second end ECU 7 to the wake-up state. The first message and the second message are, for example, set as shown in FIG. 11. DLC stands for Data Length Code, which is a field in the CAN frame that indicates the size of the data field in bytes. That is, the first message and the second message are stored in the data field of the CAN frame. Here, for simplicity, the case where the DLC is 1 byte, i.e., 8 bits, is shown.

Each bit of the 8-bit data is assigned to the switching information for IPDs 27 and 28, the startup information for the first end ECU 6, and the startup information for the second end ECU 7. In the NM frame shown in FIG. 6, the first (most significant) bit of the first data is assigned to the switching information for IPD 27, the second bit to the startup information for the first end ECU 6, the third bit to the switching information for IPD 28, and the fourth bit to the startup information for the second end ECU 7.

In the NM frame shown in FIG. 11, the first to fourth most significant bits of the first data are set to "1100." In other words, this NM frame instructs that IPD 27 be turned ON, the first end ECU 6 be transitioned to the wake-up state, IPD 28 be turned OFF, and the second end ECU 7 be transitioned to the sleep state. The first message is given priority over the second message. Furthermore, an NM frame containing both the first message and the second message corresponds to the third message.

The ECU that receives a communication frame from the mobility computer 2 determines the value stored in the predetermined bit of the received NM frame; if it is "1", the ECU transitions from the sleep state to the wake-up state or continues the wake-up state; if it is "0", the ECU transitions from the wake-up state to the sleep state or continues the sleep state.

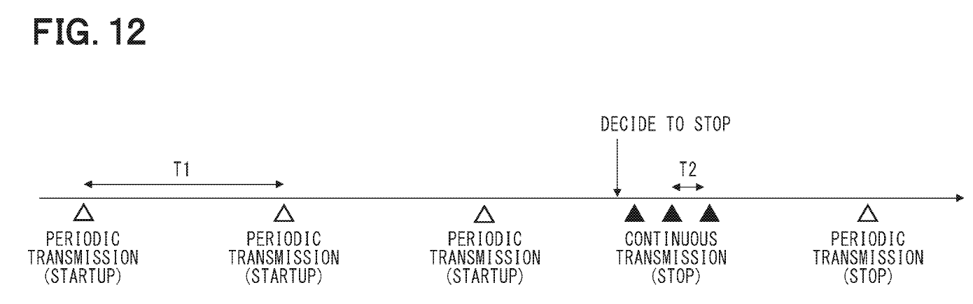

In the first embodiment, the IPD ON signal and IPD OFF signal corresponding to the first message were transmitted three times consecutively. In the second embodiment, instead of the first message, the third message is transmitted three times consecutively. The third message is transmitted at the timing when the target IPD is to be switched ON or OFF. In addition, the third message is transmitted multiple times consecutively at a fixed interval T1, and at an interval T2 that is shorter than the fixed interval. FIG. 12 shows the transmission mode of the third message described above. In the FIG., "stop decision" refers to transition to the sleep state or IPD OFF. In this case as well, the same effects as in the first embodiment can be obtained.

### Other Embodiments

The number of times the first or third message is transmitted consecutively is not limited to "3" and may be changed as appropriate. Messages for switching to the wake-up state or sleep state may also be transmitted consecutively multiple times (that is, multiple times in succession).

The present disclosure has been described in accordance with embodiments; however, it is understood that the present disclosure is not limited to such embodiments or structures. The present disclosure also encompasses various modifications and equivalents within the scope of the disclosure. In addition, various combinations and forms, as well as other combinations and forms including only one element, more than one, or fewer than those described, are also within the scope and spirit of the present disclosure.

The control unit and methods described in the present disclosure may be implemented by a dedicated computer provided by configuring a processor and memory programmed to execute one or more functions embodied as a computer program. Alternatively, the control unit and methods described in the present disclosure may be implemented by a dedicated computer provided by configuring a processor with one or more dedicated hardware logic circuits. Alternatively, the control unit and methods described in the present disclosure may be implemented by one or more dedicated computers configured by a combination of a processor and memory programmed to execute one or more functions and a processor configured with one or more hardware logic circuits. Furthermore, the computer program may be stored as instructions to be executed by a computer on a computer-readable non-transitory tangible recording medium.

What is claimed is:

1. A communication system mounted on a vehicle, comprising:
a management device; and
an electronic control unit configured to communicate with the management device,
wherein
the electronic control unit is started by power supply from an external source via a semiconductor switch, and is stopped by power disconnection from the external source via the semiconductor switch,
while in a powered state, the electronic control unit is configured to switch to perform startup by switching to a wake-up state and to stop by switching to a sleep state, based on a communication frame received from an external source, and
upon determination to stop the electronic control unit, the management device transmits, as a first transmission after the determination, a stop request to the electronic control unit multiple times in succession.

2. The communication system according to claim 1, wherein
the management device, also upon determining to start the electronic control unit, transmits a startup request to the electronic control unit multiple times in succession.

3. The communication system according to claim 2, wherein
when the management device determines to start the electronic control unit by power supply from the external source via the semiconductor switch, or to stop the electronic control unit by power disconnection from the external source via the semiconductor switch,
the management device transmits the startup request or the stop request multiple times in succession.

4. The communication system according to claim 2, wherein
the management device transmits a first message requesting the power supply or the power disconnection, and a second message requesting switching to the wake-up state or the sleep state, and transmits the first message multiple times in succession.

5. The communication system according to claim 4, wherein
when the electronic control unit does not receive a second message requesting switching to the wake-up state for a predetermined period,
the electronic control unit transitions to the sleep state by itself.

6. The communication system according to claim 2, wherein
the management device transmits, multiple times in succession, a message capable of instructing each individual electronic control unit to request the power supply or the power disconnection and switch to the wake-up state or the sleep state.

7. The communication system according to claim 6, wherein
the management device transmits the message multiple times in succession at a timing of requesting the power supply or the power disconnection.

8. The communication system according to claim 6, wherein
the management device periodically transmits the message at a fixed interval, and, when transmitting multiple times in succession, transmits the message at intervals shorter than the fixed interval.

9. The communication system according to claim 1, wherein
when the management device first transmits the request to the electronic control unit, the management device starts counting a timer, transmits the plurality of requests before the timer count reaches a predetermined value, and
when the timer count reaches the predetermined value, the management device determines a completion of power control.

10. The communication system according to claim 1, wherein
when the management device first transmits the request to the electronic control unit, the management device starts counting a timer, transmits the plurality of requests before the timer count reaches a predetermined value, and
the electronic control unit, upon executing processing in response to the requests, determines a completion of power control, and transmits a result of the determination to the management device.

11. The communication system according to claim 1, wherein
the electronic control unit includes
a first electronic control unit having the semiconductor switch, and
a second electronic control unit to which power is supplied via the semiconductor switch.

12. A management device comprising
at least one of (i) a circuit and (ii) a processor with a memory storing computer program code executable by the processor, the at least one of the circuit and the processor configured to cause the management device to communicate with an electronic control unit, the electronic control unit being started by power supply from an external source via a semiconductor switch and stopped by power disconnection from the external source via the semiconductor switch, and further being configured, while in a powered state, to perform startup by switching to a wake-up state and stop by switching to a sleep state based on a communication frame received from an external source,
wherein
the at least one of the circuit and the processor determines startup or stop of the electronic control unit, generates a startup request and a stop request for the electronic control unit, and, upon determination to stop the electronic control unit, transmits, as a first transmission after the determination, a stop request to the electronic control unit multiple times in succession.

13. A communication method executed by a management device configured to communicate with an electronic control unit which is started by power supply from an external source via a semiconductor switch, stopped by power disconnection from the external source via the semiconductor switch, and, while in a powered state, performs startup by switching to a wake-up state and stop by switching to a sleep state based on a communication frame received from an external source,
the method comprising:
determining startup or stop of the electronic control unit;
generating a startup request and a stop request for the electronic control unit; and
upon determination to stop the electronic control unit, transmitting, as a first transmission after the determination, a stop request to the electronic control unit multiple times in succession.

14. A non-transitory computer readable storage medium storing a computer program executed by a computer constituting a management device communicably arranged with an electronic control unit that is started by power supply from an external source via a semiconductor switch, stopped by power disconnection from the external source via the semiconductor switch, and that, in a powered state, is configured to perform startup by switching to a wake-up state and to perform stop by switching to a sleep state based on a communication frame received from an external source, the program causing the computer to:
determine startup or stop of the electronic control unit;
generate a startup request and a stop request for the electronic control unit; and
upon determination to stop the electronic control unit, transmit, as a first transmission after the determination, a stop request to the electronic control unit multiple times in succession.
